(19) United States
(12) Patent Application Publication
(10) Pub. No.: US 2026/0233482 A1
(43) Pub. Date: Aug. 13, 2026

(54) METHOD FOR PRODUCING A BLANK FOR DEFORMATION INTO A COMPONENT PART, AND BLANK FOR MANUFACTURING A COMPONENT PART

(71) Applicant: Airbus Operations GmbH, Hamburg (DE)

(72) Inventor: Alexei Vichniakov, Buxtehude (DE)

(73) Assignee: Airbus Operations GmbH, Hamburg (DE)

(21) Appl. No.: 19/535,215

(22) Filed: Feb. 10, 2026

(30) Foreign Application Priority Data
Feb. 11, 2025 (EP) 25157051

(51) Int. Cl. B29D 99/00; B23K 26/38; B29K 105/00; B29K 105/08

(52) U.S. Cl. CPC B29D 99/0003; B23K 26/38; B29K 2105/08; B29K 2105/256

(57) ABSTRACT

A method for producing a blank for deformation into a component part. Therein, a first section of a sheet made of a fiber reinforced composite material is designated to after the deformation become a first portion of the component part, and a second section of the sheet is designated to become a second portion of the component part. A slit pattern is generated, within the sheet, whose geometry in the first section is different from its geometry in the second section. Further disclosed are a manufacturing method for manufacturing a component part, and a blank for deformation into a component part.

### TECHNICAL FIELD

The disclosure herein concerns a method for producing a blank designated to be deformed for becoming a component part, and a manufacturing method for manufacturing a component part. The disclosure herein further concerns a blank for deformation into a component part.

### BACKGROUND

Component parts made of a composite material are often manufactured from a blank which is deformed into the required shape. Such blank is typically made of a fiber-reinforced polymer matrix. In particular, conventional blanks may be made of a sheet moulding compound (SMC) material comprising a plurality of chopped fibers, or of a pre-preg which may contain continuous fibers and/or a woven fabric. Compared to each other, an SMC material features an improved formability, whereas a pre-preg has superior mechanical performance.

To provide a blank exhibiting both advantageous mechanical properties and an improved drapability, a material known as “TORAYCA® ET40” has been proposed which is made from a unidirectional thermoset pre-preg material processed by introducing, regular slits into a tape of the pre-preg material, thereby cutting the fiber material included therein and thus creating regularly arrayed unidirectional fiber bundles. According to https://www.cf-composites.toray/products/thermoset/others/extensible.html, the application of slits improves the deformability. However, it reduces the mechanical properties of produced parts.

### SUMMARY

It is an object of the disclosure herein to facilitate fabrication of improved component parts, in particular of component parts to be integrated in a vehicle such as an aircraft.

The object is achieved by a method, by a manufacturing method, and by a blank as disclosed herein. Advantageous embodiments are disclosed in the description, and in the figures.

A method according to the disclosure herein serves to produce a blank adapted to be deformed (e.g., by stamp forming) into a component part, i.e., to be deformed so as to become - possibly after further steps such as hardening, trimming, and/or deburring - the component part. For instance, the component part may be structural part of a vehicle, in particular of an aircraft. According to specific examples, the component part may be at least a part of an aircraft’s frame or stringer (respectively of a fuselage reinforcement structure), or of an aircraft’s door surround frame, window frame, floor structure, bulkhead, or operational box.

The method comprises designating a first section of a sheet of a fiber reinforced composite material to after the deformation constitute a first portion of the component part, and further designating a second section of the sheet to after the deformation constitute a second portion of the component part. The designating of first and second section may preferably be carried out automatically, such as based on an intended three-dimensional shape of the component part, in particular based on a three-dimensional digital model of at least a portion of the component part.

The method further comprises generating a slit pattern comprising one or various slits within the sheet. Therein, a geometry of the slit pattern in the first section is different from a geometry of the slit pattern in the second section.

As is to be understood, the blank produced by way of the method thus is made of the sheet, and the deformation of the blank thus goes along with a deformation of the sheet.

A blank according to the disclosure herein is designated to be deformed (e.g., by stamp forming) into a component part such as, for instance, a structural part of a vehicle, in particular of an aircraft. According to specific examples, the component part may be at least a part of an aircraft’s frame or stringer (respectively of a fuselage reinforcement structure), or of an aircraft’s door surround frame, window frame, floor structure, bulkhead, or operational box.

The blank is made of a sheet of a fiber reinforced composite material, the sheet comprising a first section and a second section and exhibiting a slit pattern whose geometry in the first section is different from its geometry in the second section.

As is to be understood, the method according to the disclosure herein may comprise designating at least one further section of the sheet to after the deformation constitute a (respective) further portion of the component part. The slit pattern in such further portion may then be generated so as to have a geometry which is different from both its geometry in the first section and its geometry in the second section. Analogously, the sheet the blank according to the disclosure herein is made of may comprise at least one further section, wherein the slit pattern may have a geometry which in the at least one further section is different from both its geometry in the first section and its geometry in the second section.

In each of the first and the second section (and, if applicable any further section), the slit pattern is preferably regular, thus exhibits a regular (respective) slit distribution. The first and the second section (and, if applicable, any further section) are preferably (pairwise) disjoint.

The slit pattern may include a plurality of hatched and/or crosshatched (straight or bent) slits. Additionally or alternatively, the slit pattern may include at least one continuous slit running along an intricate (e.g., meandering, zigzagging, looped and/or spiralled) curve.

By virtue of the slit pattern depending, in its geometry, on a respective section of the sheet, the disclosure herein advantageously facilitates establishing a degree of deformability of the respective section in accordance with a shape of a respective portion the section will constitute, after the deformation, in the component part. Thereby, an advantageous trade-off between a deformability of the blank in the respective section on the one hand, and mechanical properties of the resulting component part on the other hand can be achieved. As a consequence, a manufacture of component parts having an increased performance is facilitated.

In particular, the disclosure herein facilitates applying slits only locally to an area which will be deformed by a forming process, and to apply different levels of the slitting depending on the required deformation in the local areas of the respective part to be produced.

In particular, a surface of the second portion of the component part may advantageously exhibit a curvature which is tighter than a curvature of a surface of the first portion (or vice versa). The geometry of the slit pattern in the respective section may then provide for an increased deformability of the second section as compared to a deformability of the first section (or, in the reversed case, vice versa).

According to advantageous embodiments of the disclosure herein, the slit pattern may be at least partially cut mechanically into the sheet.

Additionally or alternatively, at least some slit/s of the slit pattern may be at least partially laser-cut into the sheet.

Laser-cutting is well established for materials such as metal and glass. With respect to fiber reinforced composite materials, it is known in the art for trimming cured composite materials, cutting semi-finished products (such as pre-pregs, preforms, fabrics, or non-crimp fabrics), drilling, and perforating.

Generating, in accordance with the embodiments of the disclosure herein, the slit pattern at least partially by way of laser-cutting facilitates a simplified alignment of the slit/s, a highly flexible and automatable, force free application of the slit pattern into the sheet while avoiding tool wear, delamination, thermal degradation, and a complex water circuit handling. Moreover, the slit pattern being laser-cut into the sheet is characterised by highly accurate cutting edges which implicate a precisely predictable deformation behaviour of the blank.

According to advantageous embodiments of the disclosure herein, one of the first and the second section is devoid of any portion of a slit of the slit pattern; as is to be understood, absence of any slit portion is considered herein as a specific, namely void geometry of the slit pattern in the respective section, and due to the geometry of the slit pattern being different in the first and the second section, such void geometry implies that the respective other one of the first and the second section includes at least a portion of at least one slit of the slit pattern.

By thus generating the slit pattern missing out the one of the sections (thus with a void geometry in the section), particularly advantageous mechanical properties are preserved in this section which may require a low deformability, such as due to an essentially flat shape of the associated portion (of the component part) the respective section is designated to become after the deformation.

Alternatively, each of the first and the second section may comprise at least a (respective) portion of at least one (possibly respective) slit of the slit pattern. In this case, the respective geometry of the slit pattern in the first and the second section may differ from each other in a respective depth of one or various or all slits respectively formed in the first and the second section; in a mean depth of slits respectively formed in the first and the second section; in a respective length of one or various or all slits respectively formed in the first and the second section; in a mean length of slits respectively formed in the first and the second section; in a respective shape of one or various or all slits respectively formed in the first and the second section; in an arrangement of various slits or slit portions relative to each other; and/or in a size of a maximum slit-free circular area existing within the respective section (which thus relates to a slit density respectively existent in the first and the second section).

By these differences in geometries, a customised, in each case appropriate degree of deformability of the respective sections may be established.

The method according to the disclosure herein may further comprise producing the sheet. The producing may comprise tape slitting and/or cutting at least one layer of a polymer matrix. Additionally or alternatively, producing the sheet may comprise carrying out at least one step of automated fiber placement. In the latter case, the generating the slit pattern may be carried out after at least one step of the automated fiber placement.

According to specific embodiments, the method may comprise producing the sheet to include a laminate of various layers which may be of a (same or respective) polymer matrix material, and/or one or more of which may preferably be fiber reinforced. Preferably, at least two of such layers may differ from each other at least in an orientation of fibers they respectively include. The sheet a blank according to the disclosure herein is made of may analogously comprise a laminate of various layers. At least two of these layers may be made of a same or respective polymer matrix material and/or may differ from each other at least in an orientation of fibers they respectively include.

In these embodiments, the slit pattern may be generated in at least two of the layers, possibly (if applicable) subsequent to a respective automated fiber placement onto one or both of these layers.

In particular, the slit pattern may be at least partially generated after stacking the layers; in this case, at least some of the slits of the slit pattern may preferably be generated so as to penetrate at least 50% of a thickness of the laminate or even to entirely penetrate the laminate.

Additionally or alternatively, the slit pattern may be at least partially generated prior to stacking the layers and/or during a process of stacking the layers; in these cases, at least some of the slits of the slit pattern may preferably penetrate the entire depth of a respective layer.

In embodiments where the sheet includes a laminate of various layers, at least two of the layers may differ from each other at least in a respective arrangement of one or various slits of the slit pattern these layers respectively include. For example, the at least two layers may differ from each other at least in a respective (mean) depth, (mean) length, shape, and/or slit arrangement (relative to each other) of the slit pattern’s slits they respectively include, and/or in a respective size of a maximum slit-free circular area existing within the respective layer.

In embodiments of a blank (according to the disclosure herein) made of a sheet comprising a laminate of various layers, the slit pattern may analogously include slits penetrating at least 50% of a thickness of the laminate or even penetrating the entire laminate. Additionally or alternatively, it may comprise slits entirely penetrating (possibly only) individual layers of the laminate, wherein at least two layers of the blank may may differ from each other in their slits in the ways mentioned above.

The method according to the disclosure herein may further comprise tailoring the blank from the sheet. In such case, the tailoring may comprise punching out the blank from the sheet, and/or cropping its contour. According to advantageous embodiments, the tailoring may be carried out by laser-cutting an outline of the blank; such procedure advantageously facilitates a highly flexible and automatable, force free tailoring while avoiding tool wear, delamination, thermal degradation, and a complex water circuit handling. Tailoring the blank by way of laser-cutting is particularly advantageous in embodiments where also the slit pattern is generated in this way, as mentioned above.

In these embodiments comprising tailoring the blank, the generation of the slit pattern may preferably be carried out at least partially before initiation of the tailoring, at least partially simultaneously with the tailoring, at least partially in turn with at least two steps of the tailoring, and/or at least partially after completion of the tailoring.

A manufacturing method according to the disclosure herein serves for manufacturing a component part. For instance, the component part may be a structural part of a vehicle, in particular of an aircraft. According to specific examples, the component part may be at least a part of an aircraft’s frame or stringer (respectively of a fuselage reinforcement structure), of a rib or spar of a wing, or of an aircraft’s door surround frame structure, window frame, floor structure, bulkhead, or operational box.

The manufacturing method comprises producing a blank of the component part by applying a method for producing a blank according to an embodiment of the disclosure herein. The manufacturing method further comprises stamp forming the component part from the blank. The manufacturing method may additionally comprise trimming and/or deburring the stamp formed blank, and/or applying a non-destructive test to the stamp formed blank/ component part.

According to advantageous embodiments of the disclosure herein, the fiber reinforced composite material the sheet is formed of comprises at least one thermoset material (such as an epoxy matrix, for example) and/or at least one thermoplastic material (such as PEEK, PEKK, PAEK, LM PAEK, PPS, PA, PA66, PEI or PPS, for instance). The reinforcing fiber material of the sheet may include a unidirectional fiber and/or a fabric. It may include one or various carbon fiber/s, glass fiber/s, aramid fiber/s and/or other synthetic and/or natural (e.g., flax and/or cotton) fiber/s.

The first and/or the second section may preferably include a convex zone (such as a circular area or a rectangle) having surface area of at least 16cm², at least 25cm², or at least 100cm², for instance.

### BRIEF DESCRIPTION OF THE DRAWINGS

In what follows, a preferred embodiment of the disclosure herein is explained with respect to the accompanying drawings. As is to be understood, the respective features are depicted as examples only, may be facultative and/or combined in a manner different than that depicted.

Shown is schematically in

FIG. 1a: sheet a blank is to be produced from by applying a method according to the disclosure herein;

FIG. 1b: the sheet of FIG. 1a during application of the method;

FIG. 1c: a blank according to an embodiment of the disclosure herein, produced from the sheet shown in FIGS. 1a, 1b; and

FIG. 1d: a component part manufactured from the blank shown in FIG. 1c.

### DETAILED DESCRIPTION

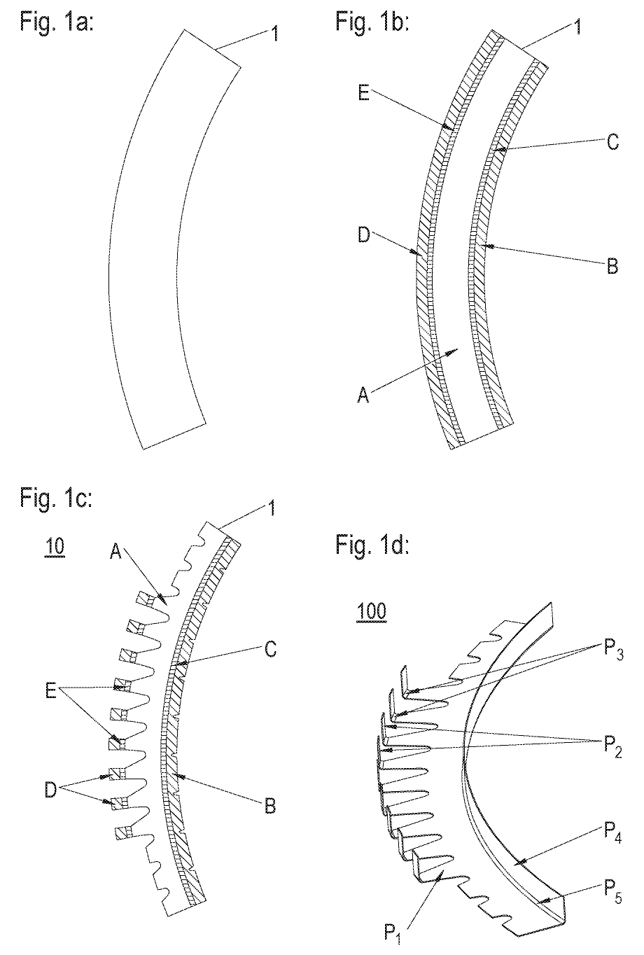

FIGS. 1a – 1c in conjunction illustrate a method for producing, in accordance with the disclosure herein, a blank 10 (shown in FIG. 1c) from a sheet 1 of a fiber reinforced composite material. The sheet 1 is depicted, in FIGS. 1a – 1c, in a top view.

FIG. 1d completes the demonstration given by FIGS. 1a to 1c to a visualisation of a manufacturing method according to the disclosure herein. Indeed, FIG. 1d depicts, in a perspective view, a component part 100 produced by deforming the blank 10, such as by way of stamp forming, possibly followed by at least one step of trimming and/or deburring (not shown) and/or a non-destructive test.

In the example case illustrated, the component part 100 is a portion of a frame to be used in constructing a reinforcement structure (not shown) of an aircraft’s fuselage.

FIG. 1a shows the sheet 1 as just slit from a tape (not shown).

In the situation illustrated in FIG. 1b, the sheet 1 has been divided in pairwise disjoint sections A, B, C, D, E in accordance with a shape of the component part 100 (see FIG. 1d) into which the blank 10 (see FIG. 1c) is intended to be deformed.

Indeed, and as apparent in consideration of FIG. 1d, a section A is designated to become a portion P₁, a section B is designated to become a portion P₂, a section C is designated to become a portion P₃, a section D is designated to become a portion P₄, and a section E is designated to become a portion P₅. Therein, as apparent from FIG. 1d, portion P₁ is flat, portions P₂ and P₄ each are shaped as a flange arched along an outer or an inner circumference, respectively, of the component part 100, and portions P₃and P₅ form edges, of the component part 100, in which the blank 10 has been bent about 90° relative to portion P₁.

In particular, a respective surface of portions P₃ and P₅ thus possess a curvature which is tighter than a curvature of respective surfaces of portions P₂ and P₄ which on their part are tighter than a (zero) curvature of the flat surface of portion P₁.

In the situation shown in FIG. 1c, the blank 10 has been tailored by cropping its contour from the sheet 1.

In accordance with the disclosure herein, the sheet 1 is provided, preferably by way of slitting, preferably laser-cutting, with a slit pattern (not shown) comprising at least one slit. Therein, a geometry of the slit pattern varies with the respective section A – E. That is, at least two of the sections may differ from each other in a geometry the slit pattern has in the respective section. For instance, one of the sections may exhibit no slits (such as in section A, for instance), while another one of the sections may include at least a portion of at least one slit, and/or two of the sections may differ from each other in a length, depth, shape and/or in a respective size of a maximum slit-free circular area existing within the respective section, and/or in an arrangement of various of its slits or slit portions relative to each other.

The sheet 1 and, therewith, the blank 10 may comprise a laminate of various layers (not shown) with different respective fiber orientations. Therein, different layers could be treated differently, as detailed above.

The geometry of the slit pattern preferably is generated so as to provide for a deformability, of the respective section, as appropriate for forming the component part 100. In the present case, section A designated to not be deformed but to form the flat portion P₁ may be devoid of any slit of the slit pattern. Thereby, a particularly high stability of portion P₁ can be achieved.

In sections B to E designated to be deformed so as to constitute portions P₂ to P₅, respectively, the slit pattern may be generated depending on a degree of deformation the section will be exposed to when the component part 100 is formed from the blank 10. For instance, as sections C, E are destined to undergo a heavier deformation than sections B, D, the slit pattern in one or both of these sections C, E may include deeper and/or longer slits or slit portions than in sections B, D, and/or one or both sections C, E may exhibit a higher slit density than at least one of sections B, D (in particular, a least one of sections C, E may include a maximum slit-free circular area having a smaller size than a maximum slit-free circular area included in at least one of sections B, D).

Thereby, the slit pattern may be generated so as to advantageously adjust the deformability of the blank, in the respective section, to a respective requirement without unduly exceeding it. Thus, an advantageous trade-off between a deformability and mechanical properties of the resulting component part can be achieved.

The generation of the slit pattern may at least partially be carried out before initiating the tailoring of the sheet (to produce the tailored blank depicted in FIG. 1c). Additionally or alternatively, at least some step of generating the slit pattern may be carried out simultaneously with the tailoring, in turn with at least two steps of the tailoring, and/or at least partially after completion of the tailoring.

In case the method comprises producing the sheet 1 using at least one step of automated fiber placement, generating the slit pattern is carried outer after at least one step of the fiber placement.

Disclosed is a method for producing a blank 10 for deformation into a component part 100. Therein, a first section A, B, C, D, E of a sheet 1 made of a fiber reinforced composite material is designated to after the deformation become a first portion P₁, P₂, P₃, P₄, P₅ of the component part 100, and a second section A, B, C, D, E of the sheet is designated to become a second portion P₁, P₂, P₃, P₄, P₅ of the component part 100. A slit pattern is generated, within the sheet 1, whose geometry in the first section A, B, C, D, E is different from its geometry in the second section A, B, C, D, E.

Further disclosed are a manufacturing method for manufacturing a component part 100, and a blank 10 for deformation into a component part 100.

Additionally, it is noted that "comprising" or "including" does not exclude any other elements or steps and "a" or "an" does not exclude a multitude or plurality. It is further noted that features or steps which are described with reference to one of the above example embodiments may also be used in combination with other features or steps of other example embodiments described above. Reference signs in the claims are not to be construed as a limitation.

### REFERENCE SIGNS

1 sheet

10 blank

100 component part

A, B, C, D, E section of the sheet 1

P₁, P₂, P₃, P₄, P₅ portion of the component part 100

1. A method for producing a blank for deformation into a component part, the method comprising:
designating a first section of a sheet of a fiber reinforced composite material to after the deformation become a first portion of the component part, and a second section of the sheet to become a second portion of the component part; and
generating, within the sheet, a slit pattern whose geometry in the first section is different from its geometry in the second section.

2. The method according to claim 1, wherein a surface of one of the first and second portions of the component part comprises a curvature which is tighter than a curvature of a surface of another one of the first and second portion.

3. The method according to claim 1, wherein generating the slit pattern comprises laser-cutting at least one or a plurality of slits into the sheet.

4. The method according to claim 1, wherein the slit pattern is generated such that one of the first and the second section is devoid of any portion of a slit of the slit pattern.

5. The method according to claim 1, wherein both the first section and the second section include at least a portion of at least one slit of the slit pattern, and the geometry of the slit pattern in the first section differs from the geometry of the slit pattern in the second section by at least one of:
a respective depth of one or various or all slits respectively formed in the first and the second section;
a mean depth of slits respectively formed in the first and the second section;
a respective length of one or various or all slits respectively formed in the first and the second section;
a mean length of the slits respectively formed in the first and the second section;
a respective shape of one or various slits respectively formed in the first and the second section;
an arrangement of the respectively included slits relative to each other; and/or
a respective size of a maximum slit-free circular area existing within the respective section.

6. The method according to claim 1, further comprising tailoring the blank from the sheet, wherein the generating the slit pattern is carried out:
at least partially before initiation of the tailoring; and/or
at least partially simultaneously with the tailoring; and/or
at least partially in turn with at least two steps of the tailoring; and/or
at least partially after completion of the tailoring.

7. The method according to claim 1, further comprising producing the sheet, wherein:
at least one step of automated fiber placement is applied, wherein the generating the slit pattern is carried out after at least one step of the automated fiber placement; and/or
the sheet is produced to include a laminate of various layers, a least two of which differ from each other at least in an arrangement of one or various slits, of the slit pattern, the at least two layers respectively include.

8. The method according to claim 1, further comprising designating at least one further section, of the sheet, to become a further portion of the component part, and wherein the slit pattern’s geometry in the at least one further section is different from both its geometry in the first section and its geometry in the second section.

9. The method according to claim 1, wherein the component part is an aircraft’s structural part that is at least a part of a frame, of a stringer, of a door surround frame, of a window frame, of a floor structure, of a bulkhead, or of an operational box.

10. A manufacturing method for manufacturing a component part, the method comprising:
producing a blank of the component part by applying the method according to claim 1, and thereafter
stamp forming the component part from the blank.

11. A blank for deformation into a component part, the blank made of a sheet of a fiber reinforced composite material, the sheet comprising a first section and a second section,
wherein the sheet comprises a slit pattern whose geometry in the first section is different from its geometry in the second section.

12. The blank according to claim 11, wherein:
the slit pattern is at least partially laser-cut into the sheet; and/or
the sheet includes a laminate of various layers, a least two of which differ from each other at least in an arrangement of one or various slits, of the slit pattern, the at least two layers respectively include.

13. The blank according to claim 11, wherein one of the first and the second section is devoid of any portion of a slit of the slit pattern.

14. The blank according to claim 11, wherein both the first section and the second section include at least a portion of at least one slit of the slit pattern, and the geometry of the slit pattern in the first section differs from the slit pattern in the second section by at least one of:
a respective depth of one or various or all slits respectively formed in the first and the second section;
a mean depth of slits respectively formed in the first and the second section;
a respective length of one or various or all slits respectively formed in the first and the second section;
a mean length of the slits respectively formed in the first and the second section;
a respective shape of one or various slits respectively formed in the first and the second section;
an arrangement of the respectively included slits relative to each other; and/or
a respective size of a maximum slit-free circular area existing within the respective section.

15. The blank according to claim 10, wherein the component part is an aircraft structural part that is at least a part of a frame, of a stringer, of a door surround frame, of a window frame, of a floor structure, of a bulkhead, of a rib of a wing, of a spar of a wing, or of an operational box.
